(19) United States
(12) Patent Application Publication
(10) Pub. No.: US 2009/0191769 A1
(43) Pub. Date: Jul. 30, 2009

(54) Contact With Improved Retention Member

(76) Inventors: Donald Alan Diemer, Oak Ridge, NC (US); David James Fabian, Mount Joy, PA (US); Donald Michael Baughn, Burlington, NC (US)

Correspondence Address: TYCO TECHNOLOGY RESOURCES, 4550 NEW LINDEN HILLS ROAD, SUITE 140, WILMINGTON, DE, 19808, US

(21) Appl. No.: 12/223,307

(22) PCT Filed: Jan. 31, 2007
(86) PCT No.: PCT/US2007/002715

§ 371 Date: Jan. 27, 2009

Related U.S. Application Data
(60) Provisional application No. 60/763,636, filed on Jan. 31, 2006.

(51) Int. Cl. H01R 13/428

(52) U.S. Cl. 439/869

(57) ABSTRACT

An electrical terminal (2) includes a body (4) having a locking member (6) and the locking member extends through an aperture (10) and backs up to the body. The locking member is configured to abut the housing, in one embodiment the locking member is disposed through the channel defined by the body while another embodiment a plurality of locking members are at least partially disposed within the channel. Preferably, the locking member is stamped out from the body. In a variation the body has a projection which can abut the housing to lock the body into the housing.

An improved electrical terminal and more particularly to an improved locking feature for the retention of the electrical terminal within a housing is described.

Several methods exist for retaining an electrical terminal within a housing. In various applications of electrical connectors, devices are utilized to lock the terminals in place and to assure that they are in proper position within the electrical connector.

Certain electrical connectors are provided with housings having cavities extending therethrough for receiving electrical terminals. One such method of retention, is to provide a stamped-out lance from the electrical terminal body which abuts a shoulder within the housing.

The objects of the invention are therefore to improve upon these known connection systems.

The objects of the invention have been accomplished by providing an electrical terminal comprising a body including a locking portion configured to lock the body in a housing. The body includes an aperture extending at least partially through the body. The locking portion defines a locking shoulder and the locking portion is positioned through the aperture. The locking shoulder is backed up by the body. Preferably, the body comprises a plurality of the locking portions and a plurality of apertures.

In another embodiment, an electrical terminal comprises a body having an aperture and a locking member extending from the body and at least partially out of the aperture where the locking member is configured to back up to the body. The locking member is configured to be biased by a housing. The locking member is configured to be biased from a first position to a second position which is toward the center of the body during insertion of the body into a housing, and to return to a third position away from the center of the body upon further insertion into the housing. The locking member extends through the aperture and backs up to the body. The locking member is an arch and provides a member to abut the housing. The electrical terminal cannot freely move in a longitudinal direction relative to the housing because of the locking member abutting the housing.

The body includes a longitudinal seam extending along a length of the body. The arch may be transverse to the seam. The aperture is located across the body from where the locking member associates with the body.

In yet another embodiment, the body further comprises a plurality of locking members, a plurality of point of connections, a plurality of apertures and a plurality of distal ends. At least one of the point of connections is configured to extend away from an adjacent side of the body, at least one of the distal ends configured to extend toward the adjacent side of the body At least one of the distal ends has a greater width in a circumferential direction than at least one of the point of connections. In a variation at least one of the distal ends is configured to back up to the body during the body insertion into the housing. The electrical terminal cannot freely move in a longitudinal direction relative to the housing because of the locking member abutting the housing. In a variation at least one of the distal ends is disposed in a channel of the body through at least one of the apertures. In another variation at least one of the distal ends is not disposed in a channel of the body through at least one of the apertures. In a separate variation at least one of the apertures is defined by a cutout of a point of connections and at least one of the distal ends.

The body includes a projection where the projection is configured to abut a shoulder of the housing during the body insertion into the housing to thereby prevent further insertion of the body into the housing beyond a locking position. In a variation the projection is a rib where the rib is circumferentially disposed around the body.

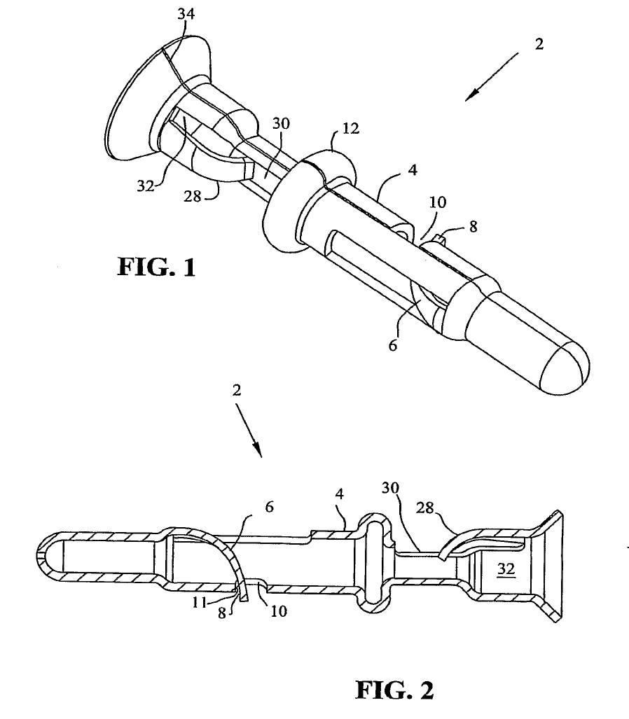

FIG. 1 is a perspective view showing an embodiment of the electrical terminal of the present invention;

FIG. 2 is a longitudinal cross-sectional view through the terminal of FIG. 1;

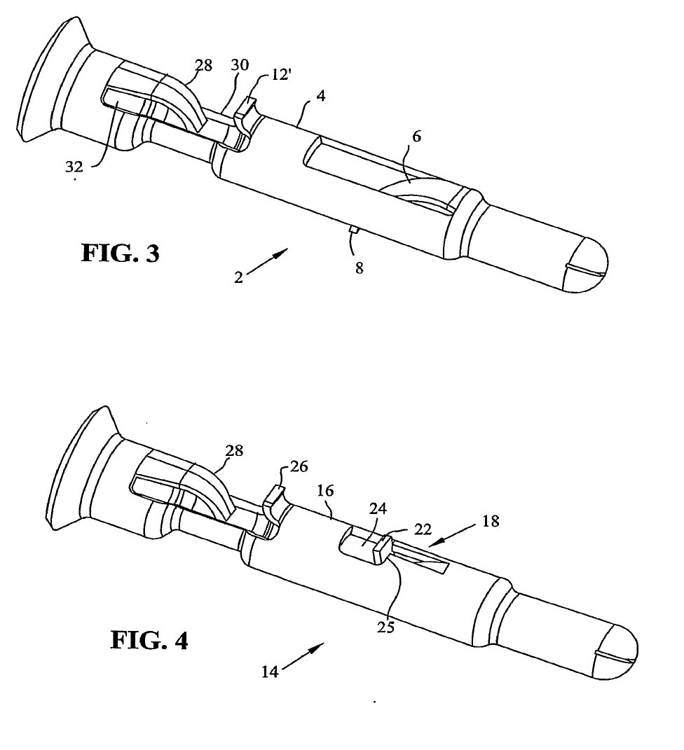

FIG. 3 shows the terminal of FIG. 1 with an alternative projection;

FIG. 4 is a perspective view showing a second embodiment of the electrical terminal of the present invention;

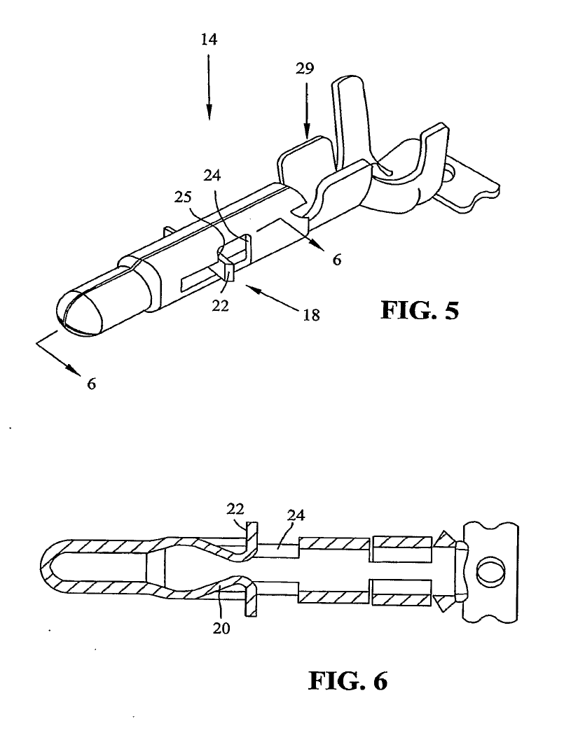

FIG. 5 is a perspective view similar to that of FIG. 4, with a wire crimp as the connection end;

FIG. 6 is a longitudinal cross-sectional of the electrical terminal through lines 6-6 of FIG. 5;

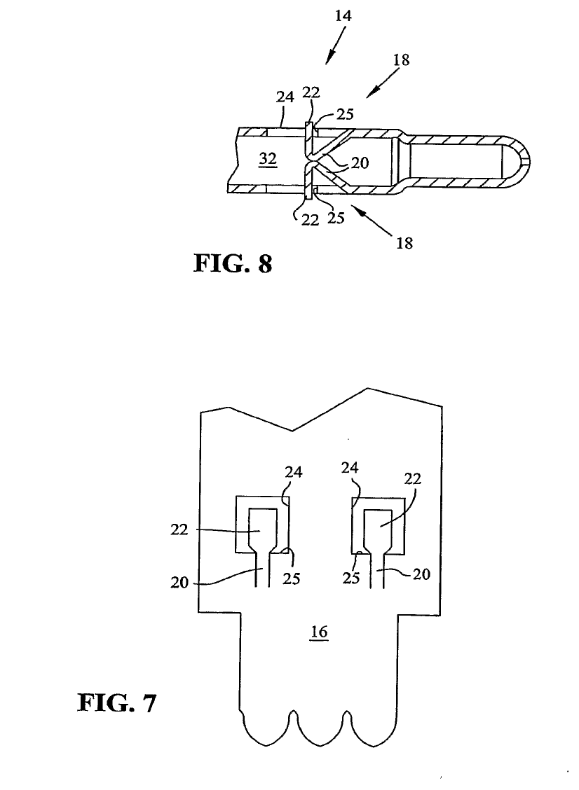

FIG. 7 shows a portion of the stamped blank of the electrical terminal of FIG. 5;

FIG. 8 shows the terminal of FIGS. 5 and 6 with the locking members moved to their fully inward position;

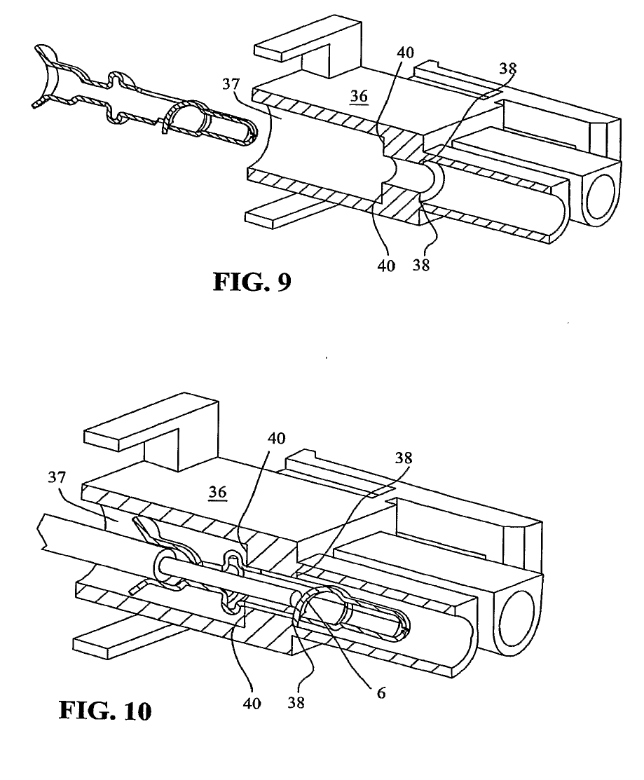

FIG. 9 shows the terminal of FIG. 1 shown poised for receipt within a connector housing; and

FIG. 10 shows the configuration of FIG. 9, in a fully locked position.

With reference first to FIG. 1, an electrical terminal is shown at 2, having a body 4, locking member 6, defining locking shoulder 8 extending through aperture 10. Locking member 6 may be a cut out or a stamp out from body 4. Locking member 6 may be resiliently biased into an arch or beam structure. Locking member 6 is shown as formed to extend through aperture 10. As best shown in FIG. 2, locking shoulder 8 is positioned adjacent to a forward edge 11 of body 4 which defines aperture 10.

As shown in FIG. 1, terminal 2 is stamped and formed from a flat blank material, where the flat blank is roll formed into a pin configuration, and where the side edges of the blank are formed into an abutting longitudinal seam 34. Also as shown, locking member 6 is stamped from the blank which forms an opening in body 4, and locking member 6 is thereafter formed to extend through opening 10.

Body 4 further includes projection 12. As shown in FIG. 1, projection 12 is shown as a bulbous form, but it should be appreciated that the projection could be a tab cut out or stamped out from body 4. For example, and with reference to FIG. 3, the projection may be in the form of a tab 12′ stamped from body 4.

With reference again to FIG. 1, body 4 further includes contact gripping element 28, aperture 30, channel 32 and seam 34. The contact gripping element 28 defines a wire trap for contacting a bare conductor of an insulated wire.

With reference now to FIGS. 4-6, terminal is shown at 14 having body 16 having a plurality of locking members 18 having a plurality of beam sections 20 and a plurality of locking ends 22, extending through a like plurality of apertures 24. Beam sections 20 and locking ends 22, may be cut outs or stamp outs from body 16. As shown in FIG. 4, terminal 14 includes a contact gripping member 28, whereas in FIG. 5, the terminal 14 includes a wire crimp connection 29.

With respect now to FIG. 7, the pin end portion of the terminal 14 is shown in the flat blank condition. As shown, the beam sections 20 and locking ends 22 are stamped from the body portion 16 prior to the forming. It should be appreciated from viewing FIG. 6 that the locking ends 22 are wider than the beam section 20 and thus when stamped and formed into the configuration of FIG. 5, locking ends are positioned adjacent to a forward edge 25 of stamped aperture 24.

More particularly, the locking sections are formed by stretching and compressing the beam sections 20, such that the sections 20 are longer than the apertures through which they were stamped. Thus when formed, and as best shown in FIGS. 5 and 6, the locking ends 22 are positioned adjacent to edges 25 which help to reinforce or back up the rigidity in the locking members 18.

At the same time, the sections are formed such that they contact each other when biased inwardly. As shown in FIG. 8, the locking ends are moved inwardly to the position where beam sections are touching. However, the beam sections bottom out before the locking ends extend through their respective aperture 24. This prevents the locking ends from getting caught inside of the terminal body. As the beam sections contact each other, spring back is provided to the beam sections, forcing them back through the apertures 24 after compression. This also prevents undue stress at the root of the connection point of the beam sections 20 and the body 16.

With the individual components as previously described, the function of one embodiment of electrical terminal 2 will now be described in greater detail. The following described function is equally applicable to other disclosed embodiments.

As best shown in FIG. 9, a connector housing 36 is shown having a cavity 37 into which either of terminals 2 or 14 can be positioned. Housing 36 has a first shoulder 38 and second shoulder 40. With respect to FIG. 10, terminal 2 is shown inserted into housing 36, with locking shoulder 8 (FIG. 2) abutting first shoulder 38, and with projection 12 abutting shoulder 40. Shoulder 8 would be rigidified by edge 11, reinforcing the locking engagement of terminal 2 to housing 36.

It should be appreciated that the embodiment of FIGS. 4-8 would be locked into housing 37 in much the same way with locking ends 22 positioned adjacent housing surface 38, and with projections 26 adjacent to surface 40. While not shown, it should be appreciated that locking members could alternatively be formed with the beams 20 extending outside of the body portion, and with locking ends projecting from outside-in, forming an alternative locking shoulder.

What is claimed is:

1. An electrical terminal, comprising:
a body having an aperture; and
a locking member extending from said body and at least partially out of said aperture, configured to back up to said body.

2. The electrical terminal of claim 1, wherein said locking member is configured to be biased by a housing.

3. The electrical terminal of claim 1, wherein said locking member is configured to be biased from a first position to a second position toward center of said body during said body insertion into a housing, and to return to a third position away from the center of said body upon further insertion into the housing.

4. The electrical terminal of claim 1, wherein said locking member extends through said aperture.

5. The electrical terminal of claim 1, wherein said body further comprises a plurality of said locking members, a plurality of point of connections, a plurality of said apertures and a plurality of distal ends.

6. The electrical terminal of claim 5, wherein at least one of said point of connections is configured to extend away from adjacent side of said body, at least one of said distal ends configured to extend toward the adjacent side of said body, said at least one of said point of connections associated to said body, said at least one of said distal ends having a greater width in a circumferential direction than said at least one of said point of connections, said at least one of said distal ends configured to back up to said body during said body insertion into the housing.

7. The electrical terminal of claim 5, wherein said plurality of said locking members comprise a stopping means to prevent further insertion of the electrical terminal.

8. The electrical terminal of claim 5, wherein at least one of said distal ends is disposed in a channel of said body through at least one of said apertures.

9. The electrical terminal of claim 5, wherein at least one of said apertures is defined by a cutout of said at least one of said point of connections and at least one of said distal ends.

10. The electrical terminal of claim 1, wherein said body includes a projection, said projection configured to abut a shoulder of the housing during said body insertion into the housing to thereby prevent further insertion of said body into the housing beyond a locking position.
